(19) United States
(12) Patent Application Publication
(10) Pub. No.: US 2016/0235249 A1
(43) Pub. Date: Aug. 18, 2016

(54) Coffee Grinder Remote Control and Data Collection Device

(71) Applicant: Michael Teahan, Glendale, CA (US)

(72) Inventor: Michael Teahan, Glendale, CA (US)

(21) Appl. No.: 15/042,085

(22) Filed: Feb. 11, 2016

Related U.S. Application Data
(60) Provisional application No. 62/116,172, filed on Feb. 13, 2015.

(51) Int. Cl. A47J 42/38; A47J 42/56; A47J 42/48; A47J 42/40

(52) U.S. Cl. CPC A47J 42/38; A47J 42/40; A47J 42/56; A47J 42/48

(57) ABSTRACT

The ability to grind coffee as needed and in the precise quantity required is key to ensuring quality because once ground it begins to oxidize rapidly and lose much of its flavor and aroma. One embodiment of this invention converts existing coffee grinders into portion controlled grind-on-demand devices, grinding only what is required for immediate use. When used with a remote, wireless activation device to select the portion desired, either by time or by weight, this conversion is possible without any grinder modifications. Additionally, this invention collects usage, date and time information for amount of coffee ground independently from the remote activation device. Inventory, quality and consumption data can be tracked via the internet in real time, independent from its portion control capabilities. Finally, as a wireless device it can collect information from other wireless devices, adjusting the quantity of ground coffee delivered to maintain quality.

This application for a Utility Patent claims benefit of a prior application for provisional patent No. 62/116,172 filed Feb. 13, 2015.

### BACKGROUND OF THE INVENTION

Coffee is a food product that reacts quickly to sunlight and exposure to air, especially once ground from its bean form into particles in order to be brewed into a beverage. Essential oils and sugars present in the roasted bean oxidize and when combined with humidity in the air undermines the quality of an otherwise properly prepared coffee drink. Grinding only as much coffee as is required to produce a beverage immediately has been the goal of many retail coffee operators, especially when it comes to espresso based drinks because the fineness of the grind makes it particularly vulnerable to oxidation. Unfortunately, many espresso grinders are designed to grind batches of coffee at a time and dispense pre-ground coffee from a mechanical dosing device. When too much coffee is ground and not used quickly, it is wasted. When not enough coffee is ground, the grinder must be turned on and off repeatedly until just enough coffee is ground for immediate use.

Many espresso grinders in use today also lack safety devices that prevent the motor from turning the grinding burrs and sweeping mechanism while the doser lid is removed. The coffee ejection chute inside the dosing chamber is large enough that a finger could be inserted while the grinder motor still rotates, potentially causing a significant injury to the operator.

Coffee Shop owners and roasters have also sought viable methods to track coffee consumption and record usage data in order to properly schedule maintenance of their machines and manage inventory. Previous attempts to record data include simple counters on coffee grinders or counting the number of times a button is pressed on an espresso machine. The problem is that espresso grinders often require more than one pull on the dispensing lever to deliver the correct amount of coffee and espresso machines are unable to differentiate between a button pressed to deliver coffee and a button pressed simply to rinse filters and cups. This inaccurate data is kept on the machine itself and there is no facility to automatically collect and analyze usage information.

Some newer coffee grinders can use time as a means to portion control delivery of ground coffee, but those systems are hardwired into the machines and would require extensive modifications to fit to existing grinders. Even if installed they would still provide no mechanism to communicate usage data for remote access and evaluation.

### SUMMARY OF THE INVENTION

The proposed invention addresses all of the inherent problems with existing coffee grinders by providing a means to control the grind time for a coffee grinder via Wi-Fi, Bluetooth or similar method for several portion options, without the need to modify the wiring or grinder internal components in any way. With a simple selection via wireless controller, the desired amount of coffee is precisely ground to order, eliminating waste and ensuring freshness of the product. The portion controls can be programmed wirelessly via the internet or wireless device. Additionally, because the device monitors usage of the grinder and stores data for remote access via the internet or wireless device, real time consumption data for coffee can be uploaded to store managers and coffee roasters to adjust inventory, roasting and order schedules. For grinders that have built-in timed delivery of ground coffee, this device serves to monitor usage and grinder burr wear without need of the remote transmitter. All of this is achieved by simply plugging the coffee grinder into the device that is in turn plugged into a power outlet and in some embodiments of the invention, replacing the existing lid on the espresso grinder. In another embodiment of the invention, the technology to monitor and send usage data about coffee consumption on the grinder can be integrated into new coffee grinders at the manufacturing level.

### BRIEF DESCRIPTION OF THE DRAWINGS

FIG. 1 is a perspective view of one example of the installed device;

FIG. 2 is a top view of one embodiment of the grinder remote control;

FIG. 3 is a top view of an alternate embodiment of the grinder remote control;

FIG. 4 is a side view of the grinder remote control;

FIG. 5 is a perspective view of the grinder remote control assembly;

FIG. 6 is a top view of the circuit board for the receiver and controller;

FIG. 7 is a perspective view of the receiver and controller enclosure;

FIG. 8 is flow chart of one representation of the invention's operation;

FIG. 9 is a flow chart for programming the device;

FIG. 10 is a perspective view of the device installed without remote control;

FIG. 11 is a perspective view of the device installed as a factory modification;

### DETAILED DESCRIPTION OF THE INVENTION

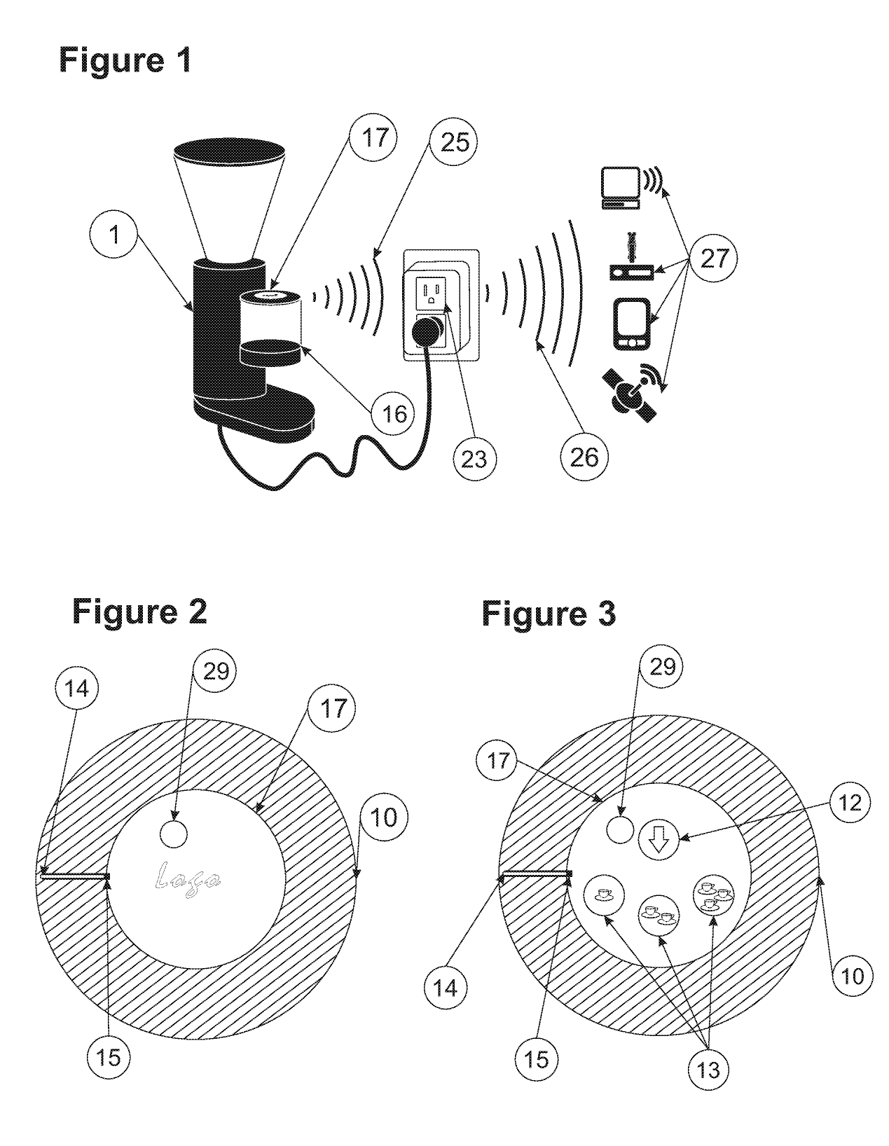

FIG. 1 shows a typical coffee grinder 1 with device remote control 17 fitted to a grinder's ground coffee dispenser 16, wireless communication 25 to receiver/controller 23, wireless communication 26 from receiver/controller 23 to the internet and/or intranet connected devices 27.

A typical coffee grinder for espresso style coffee 1 grinds coffee in batches and is portioned from a ground coffee dispenser 16. These dispensers by themselves are rarely accurate and the quantity of ground coffee in the dispenser dramatically changes the coffee dispensed due to weight and volume of coffee in the chamber. A touch sensitive remote transmitting device 17 attached to the top of the dispenser 16 replacing the pre-existing cover allows multiple doses of coffee to be delivered on demand in response to a series of sequential touches with the operators hand to the touch sensitive surface of the device or, alternately by pressing or touching a pictured icon representation of the desired portion to be ground. The remote transmitting device 17 sends the requested coffee delivery selection via radio frequency or similar transmission method 25 to the receiver/controller 23 that is plugged into a conventional wall outlet. The receiver/controller starts the grinder, which is left in the run position on the grinder 1, and stops after the preprogrammed time of delivery has been achieved. The ground and portioned coffee is then dispensed from the doser device 16 by the operator. The internal mechanism of the dosing chamber 16 can be replaced with a funnel shaped insert that delivers the coffee directly without user intervention or the whole dosing assembly 16 can be replaced with a funnel shaped delivery device.

The receiver/controller device 23 records the information including but not limited to which program was selected by the operator, time of day, location data and amount of coffee ground and transmits that information via wireless signal including but not limited to, WiFi, Bluetooth, RFID, cellular or other similar method 26 to a cloud based server, wireless device, computer or similar device 27 connected to the internet or internal wireless network.

FIG. 2 is a top view of one embodiment of the remote control transmitting device 17 fitted to the grinding chamber lid 10, a wireless transmitter 29, an interlock pin 14 and spring-loaded safety cut-off switch 15.

By using a touch sensitive sensor as part of the transmitting device 17, resistive, capacitive or with a small micro-switch, a single sensor can deliver several pre-100 programmed dosing requests when the operator to the device delivers a series of sequential taps or touches. This eliminates the need for operators to divert their attention to the grinder to select the desired portion. Using a single sensor without moving parts reduces costs and increases the working lifespan of the device. Many coffee grinders have openings between the dosing chamber and the rotating grinding mechanism that pose a risk of injury if the grinder is turned on with the dosing cover removed. In the proposed invention, a pin 14 is inserted into a pathway molded into the dosing lid 10 that, when properly fixed to the dosing chamber, depresses the micro switch 15 and enables the operation of the remote control transmitting device 17. Additionally, simply removing the lid and securing it away from the grinder disables the coffee grinder and prevents unauthorized access.

FIG. 3 is a top view of an alternate configuration for selecting a desired portion of ground coffee with individual dosing selections 13, a continuous operation button 12, the wireless transmitting device 17 fitted to the grinding chamber lid 10, a wireless transmitter 29, an interlock pin 14 and spring-loaded safety cut-off switch 15.

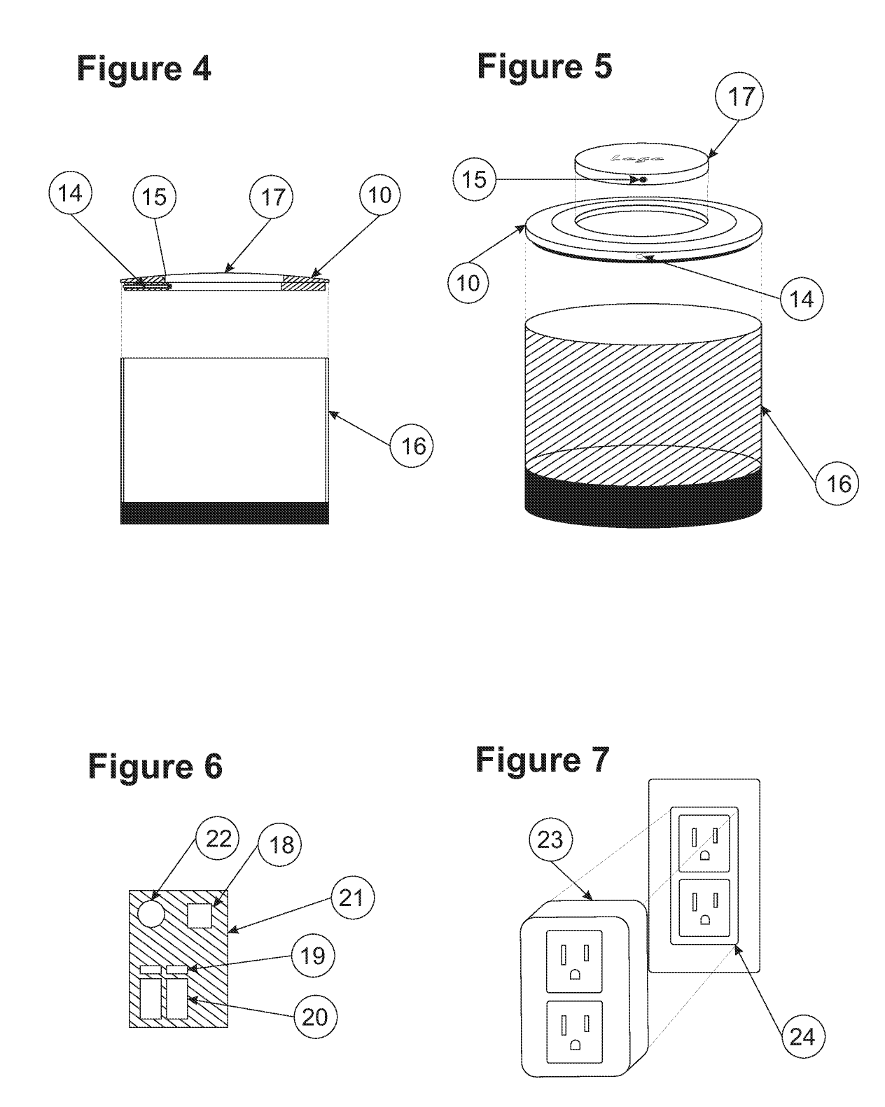

FIG. 4 is a side view of the remote transmitting component of the invention 17 fitted into dosing lid 10, push pin 14 and safety switch 15, relative to its placement into customer's pre-existing dosing chamber 16.

When the lid 10 is inserted into dosing chamber 16, push pin 14 is driven by the internal surface of the wall of dosing chamber 16, closing the safety switch 15 and allowing the remote transmitter component to operate.

FIG. 5 is a perspective view of the method of assembly for the transmitting device 17 into dosing lid 10 in relation to its insertion into the pre-existing dosing chamber 16.

FIG. 6 shows a proposed layout of the logic board 21 for the receiver controller, with a wireless receiver 22, transmitter 18, current sensor(s) 19 and relay(s) 20.

The logic controller receives the signal from a remote transmitter via receiver 22 and triggers relay 20 to start the grinder, removing power to the relay once the program has completed its designated cycle. A current sensor 19 measures the actual run time of the grinder.

Using a current sensor to measure and verify grinder operation insures that the amount of coffee dispensed is accurate. Because the remote transmitting device and receiver/control are not wired into the grinder itself, it is possible for the operator to make a selection while the grinder is turned off or unplugged from the receiver/controller. Using a current sensor 19 in addition to the relay 20 insures that the amount of coffee ground that is recorded by the device is actually delivered. This method also allows for a text message, email alert or similar notification system to be sent to a store manager or service agent when an error in delivery or device malfunction has occurred. Multiple relays 20 and sensors 19 allow the receiver/controller to operate more than one grinder.

Because this is a wireless connected device, future internet or Wi-Fi connected espresso machines can feed usage data to the device about espresso delivery times so that the invention can recommend grinder setting adjustments to the operator. Recommended changes can be accepted remotely and programmed into the receiver controller via the internet, Wi-Fi, Bluetooth or similar wireless technology.

FIG. 7 shows the enclosure 23 for the receiver/controller logic board 21 fitted to a standard wall outlet 24.

By having the logic board and enclosure plugged into an outlet, it provides constant power and remote accessibility.

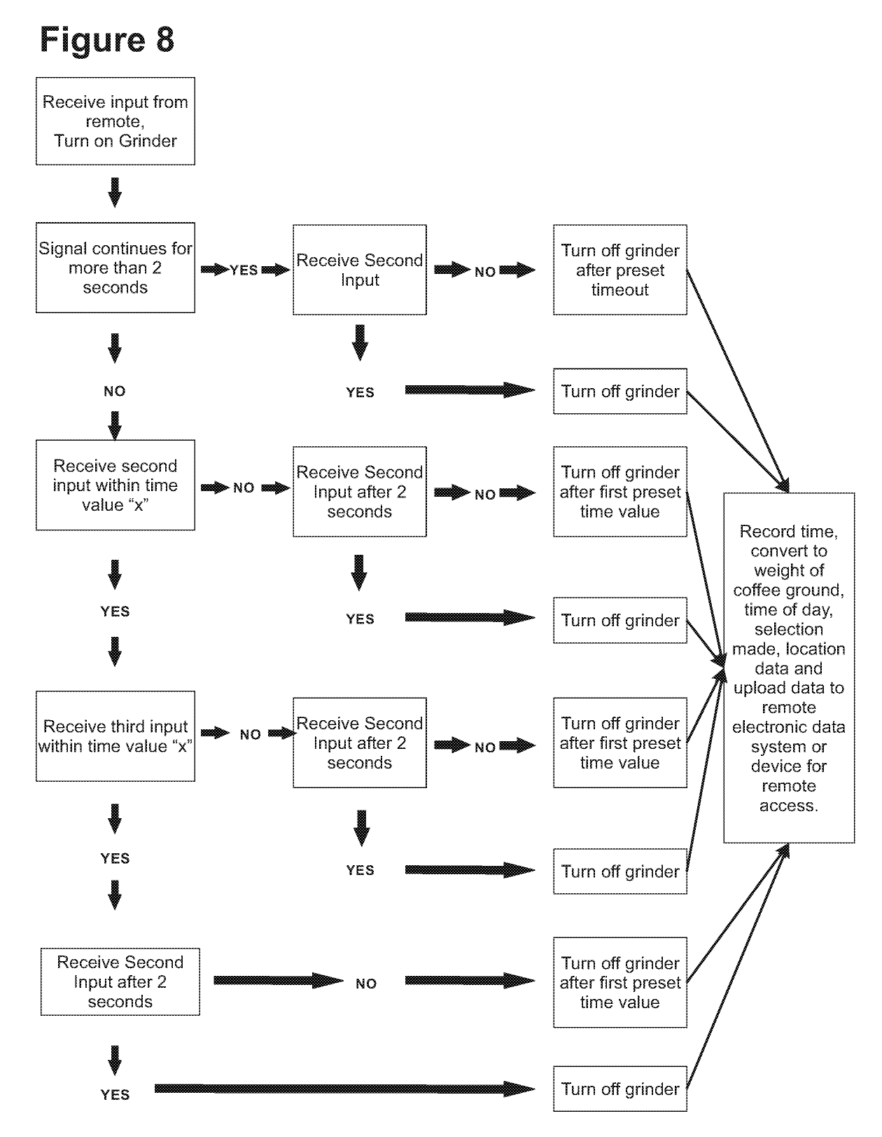

FIG. 8 shows the flow diagram for the operation of the logic controller/receiver when wirelessly connected to the single input transmitter device pictured in FIG. 2.

Using a single sensor provides a large target for the operator to initiate programmed coffee grinder settings without diverting their attention from their customer. This embodiment of the invention's input method allows the operator to simply tap the top of the transmitter with their finger or part of the hand with a series of taps to register one of several program cycles. For example, tap once for the first time value, twice for the second and three times for the third. An unlimited number of values can be entered 155 and the cycle can be interrupted at any time with a single touch after a programmed time window has expired.

Additionally, this method is not limited to a sequence of touches and may include a multi-touch interface where one, two or more fingers touched to the surface of the sensor can initiate a corresponding program.

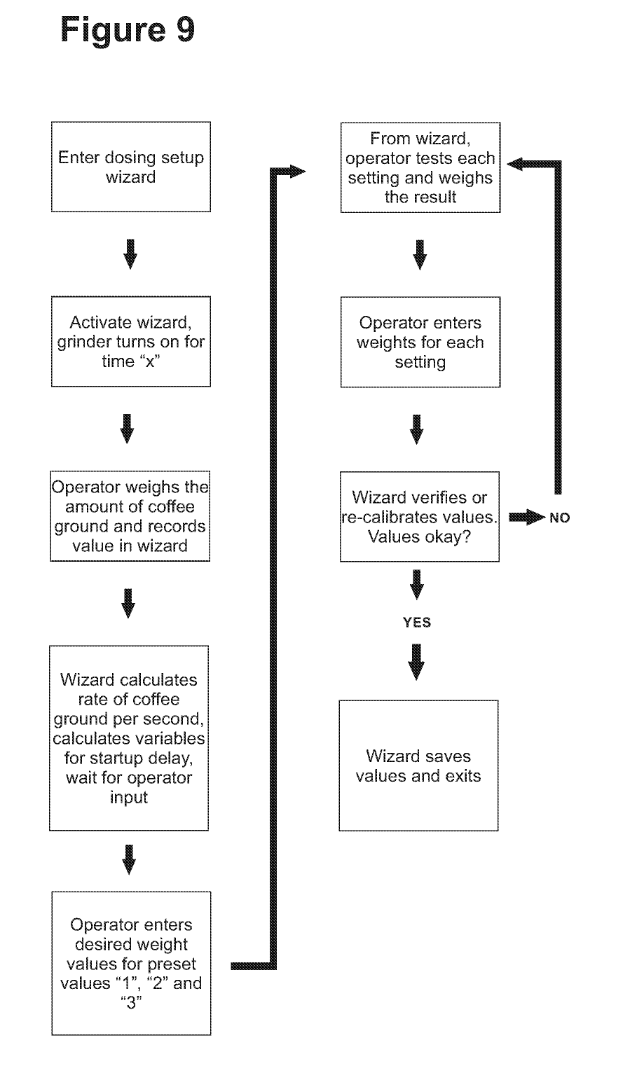

FIG. 9 shows a flow diagram for a programming wizard to set the coffee portions on the logic board.

Every grinder processes coffee at a different rate according to the size and rotation speed of the grinding burrs or the amount of wear on the surface of the mill. Additionally, when coffee varieties are changed or there is a change in the roast level of the coffee beans, the fineness of the grind must be adjusted, which changes the amount of coffee delivered for the programmed amount of time. This requires re-setting the grind time values. Grinding numerous samples of coffee and weighing them in order to set the portion values is a tedious process and can waste a great deal of coffee. This wizard allows the operator to grind one sample for a fixed amount of time and enter the resulting weight into the program wizard, where the program will make a preliminary recommendation time values for the operator's desired coffee weight. This calibration technique dramatically reduces the time necessary to program the time values for a coffee grinder, regardless of age, manufacturer or model.

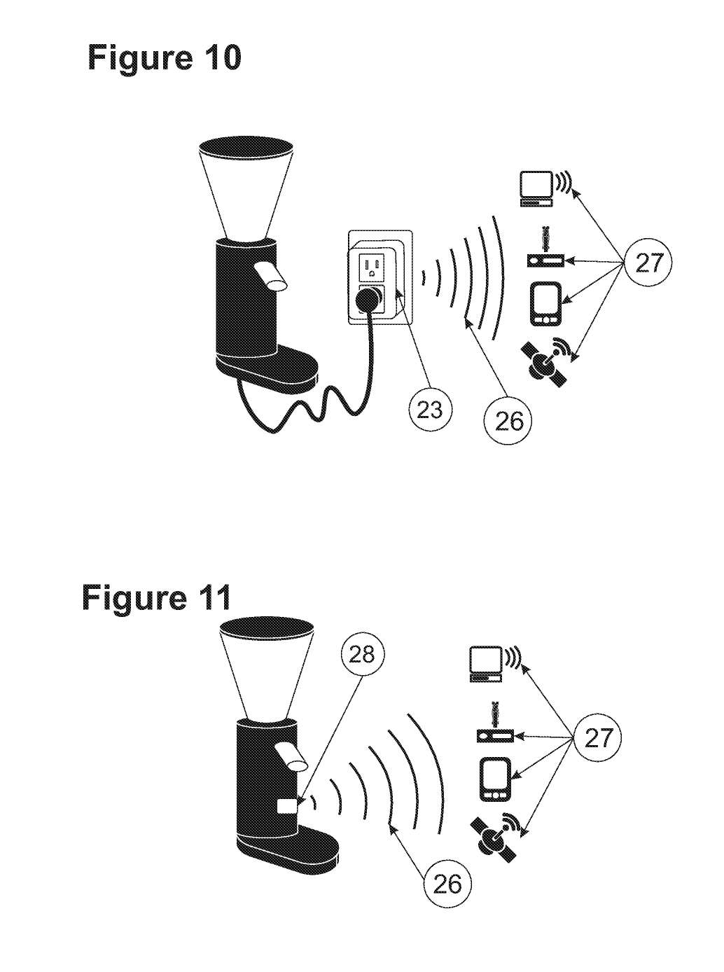

FIG. 10 shows another implementation of the receiver/controller device 23, a wireless signal 26 to communicate to track coffee consumption without the use of the remote transmitter 23 to the internet and/or intranet connected devices 27.

Newer timed dosing coffee grinders have been developed for the coffee industry in order to meet the demand for freshly ground coffee and reduce waste, but these grinders still lack the ability to track complex usage data and store or upload that data to remote devices. Because the receiver/controller senses current used by the coffee grinder(s), it can record usage data for remote evaluation and collection for any grinder to which it is attached. The data includes but is not limited to: grind time for the life of the machine and grind time since last cleaning or burr replacement, portions delivered by size, time of day and date. Because the grinder uses current sensing, excess current draw that could represent a fault in the grinder can be communicated immediately to a designated third party by text message, email or similar means. Additionally, third parties can be notified when a grinder is not used when it is expected to be operated, indicating a potential fault with the grinder.

FIG. 10 demonstrates the receiver/controller logic board 28 fitted to a grinder as part of the manufacturing process, a wireless signal 26 to communicate to track coffee consumption without the use of the remote transmitter 23 to the internet and/or intranet connected devices 27.

The data collection and wireless connectivity are valuable tools for operators and the proposed invention can be integrated into new grinders without the need to use an external receiver controller. This embodiment of the device can log keyed inputs as well as current sensing to insure that the grinder operates as expected when the operator initiates a programmed setting.

The advantages of the present invention include, without limitation, the ability to program preset values via a remote device including but not limited to Wi-Fi, Bluetooth or the internet connected device; the ability for the device itself to call for service when self diagnostics register a problem with the grinder or device; the ability to track consumption of coffee and wear on components remotely either in batches or in real time and to analyze captured data for inventory and accounting purposes; the ability to grind a variety of timed portions of coffee with a single input device either through a series of sequential contacts or simultaneous touches with one or more fingers; the ability to provide on-demand coffee delivery for a variety of portion sizes to existing grinders not fitted with portion control without modifying the internal components of the grinder; the ability to record and transmit usage data for any grinder, whether or not equipped with on-demand portion capability, without having to modify the existing grinder in any fashion; the ability to incorporate this wireless transmission technology into newly manufactured grinders. The safety device built into the transmitting device when fitted provides an extra layer of user protection from injury by preventing operation of the grinder when the ground coffee dosing chamber lid is removed.

In broad embodiment, the present invention is a more efficient and precise method of delivering coffee on demand than those currently available, adding data collection and analysis capabilities not currently available in any existing coffee grinder.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The invention claimed is:

1. A device that plugs into a standard wall outlet into which one or two coffee grinders are in turn connected by their respective power cords.

2. A Bluetooth, WiFi or similar transmitting device that accepts user input and conveys said input to the device according to claim 1.

3. A device according to claim 1 that senses the current drawn by each grinder to determine the length of time each grinder operates.

4. A method according to claim 1 that differentiates the operational time span of each event to determine the amount of coffee ground per event.

5. A device according to claim 1 that connects wirelessly to the internet to send and receive usage data and program information.

6. A device according to claim 1 that connects wirelessly to other WiFi, Bluetooth or similar devices to receive user portion requests by timed delivery.

7. A device according to claim 1 that connects wirelessly to other WiFi, Bluetooth or similar devices to receive user portion requests by weight.

8. A device according to claim 1 that connects wirelessly to external devices that measure the time or quantity of brewed coffee delivered.

9. A method according to claim 7 to increase or decrease the quantity of coffee ground by the attached grinder when activated by the device of claim 1, the result being to increase or decrease the duration of the brewed coffee extraction.

10. A device according to claim 2 that with an optional adapter can replace the existing ground coffee hopper lid, incorporating a sensing mechanism so that if removed from the coffee grinder will disable the device of claim 1 as a safety precaution.

11. A device according to claim 2 that can alternately be fitted to a counter mounted housing so that it can be activated separately from the grinder.

12. A device according to claim 2 that accepts input via designated portion controlled selections

13. A method according to claim 1 to calculate the preset portion selected by the user according to a sequence to touches via mechanical or capacitive touch sensor fitted to the device of claim 2.

14. A method according to claim 1 to calculate the preset portion by the user according to the number of fingers that simultaneously may contact with a capacitive touch sensor fitted to the device of claim 2.

15. A method to send an alert, via email, text message or similar conveyance when the control device according to claim 1 is activated but no current is detected according to claim 3.

16. A method using the device according to claim 1 to disable the grinder remotely, such as when service is required or to prevent use during specified times of day.

17. A method to collect and organize usage data via the device according to claim 1 from one or several grinders according, including but not limited to: grinder identification data, motor run time, calculated weight of coffee ground, time of day for each activation, selection made and geographical location data.

18. Alternately, the device according to claim 1 could be integrated into a coffee grinder at the time of manufacture to utilize all of the features of the device, allowing the grinder to be plugged into the wall directly.

19. A simplified method to calculate the time necessary to deliver a specified portion of coffee where the controlling device grinds a sample of coffee, and the user inputs the weight of the coffee ground.
